(19) United States
(12) Patent Application Publication
(10) Pub. No.: US 2021/0252979 A1
(43) Pub. Date: Aug. 19, 2021

(54) CONTROL SYSTEM AND METHOD FOR CONTROLLING A VEHICLE

(71) Applicant: BCS AUTOMOTIVE INTERFACE SOLUTIONS GMBH, Radolfzell (DE)

(72) Inventors: NIKOLAJ POMYTKIN, Konstanz (DE); RICHARD KUKUCKA, Ann Arbor, MI (US); STEFAN BOESHAGEN, Kreuzlingen (DE)

(21) Appl. No.: 17/159,265

(22) Filed: Jan. 27, 2021

(30) Foreign Application Priority Data
Jan. 28, 2020 (DE) 102020102014.7

(51) Int. Cl. B60K 35/00; B62D 1/06; B62D 1/08; G06F 3/0484; G06F 3/0482; G06F 3/0488; G06F 3/0481

(52) U.S. Cl. CPC B60K 35/00; B62D 1/06; B62D 1/08; G06F 3/04847; G06F 3/0482; G06F 3/04883; G06F 2203/04808; B60K 2370/782; B60K 2370/143; B60K 2370/146; B60K 2370/158; B60K 2370/157; G06F 3/04817

(57) ABSTRACT

An operating system for a motor vehicle has a steering wheel (10) comprising a steering-wheel rim, a first input device (14) assigned to the steering wheel (10), a second input device (16) assigned to the steering wheel (10), and a processing unit (18) which is connected in a signal-transmitting manner to the first input device (14) and to the second input device (16). The operating system is characterized in that the first input device (14) is spatially separated from the second input device (16), the first input device (14) being assigned to a first side of the steering wheel, and the second input device (16) being assigned to a second side of the steering wheel opposite to the first side, the first input device (14) and the second input device (16) being operatively coupled to the processing unit (18) such that a main function (38) can at least be preselected via the first input device (14), and a subfunction (44) assigned to the main function (38) being adapted to be controlled via the second input device (16).

The invention relates to an operating system for a motor vehicle, having a steering wheel for steering the motor vehicle, which comprises a steering wheel rim and at least one steering wheel spoke, a first input device, which is assigned to the steering wheel, a second input device, which is assigned to the steering wheel, and a processing unit, which is connected in a signal-transmitting manner to the first input device and to the second input device, the processing unit being configured to detect a manual input on the first input device and a manual input on the second input device and to convert them into a control of a vehicle function. Furthermore, the invention relates to a method for operating a motor vehicle.

In generic operating systems, the input devices generally function independently of each another, and a specific, limited number of vehicle functions can be controlled by each input device.

Typically, several inputs must be made in succession to control a vehicle function, which is time-consuming and little intuitive.

For this reason, important or frequently used functions are typically each accessible by a separate button of the operating system in the vehicle. However, since a separate switching element, such as a button, must be provided for each vehicle function, the space requirement increases, especially due to the increasing number of vehicle functions in modern motor vehicles.

Since at the same time the size of the screens in motor vehicles also increases in order to provide the various information to a vehicle occupant, the installation space available for the switching elements is further limited.

Up to now, the problem has been solved, for example, by configuring the screens used such that they capable of input, for example in a capacitive manner, so that a vehicle occupant could simultaneously use the screen provided for displaying the information as an input means.

The object of the invention is to create an intuitive operating system which has a high number of controllable vehicle functions while requiring few components and little space.

According to the invention, the object is achieved in a generic operating system in that the first input device is spatially separated from the second input device. The first input device is assigned to a first side of the steering wheel and is for example arranged on a rear side of the steering wheel facing away from the operator, whereas the second input device is assigned to a second side of the steering wheel opposite to the first side, the second input device being for example arranged on a front side of the steering wheel facing toward the operator. Here, the first input device and the second input device are operatively coupled to the processing unit such that a main function can at least be preselected via the first input device and a subfunction assigned to the main function can be controlled via the second input device.

In other words, the (pre)selection of the main function via the first input device makes it possible, for example, to choose and/or select a determined set of subfunctions specific to the (pre)selected main function, from which a subfunction can then be selected and executed. Accordingly, the main function represents a categorization or a menu item in which subfunctions that are usual for and specific to the category or menu item are subordinated. A large number of available subfunctions can thus be clearly subdivided, enabling intuitive and clear control of the subfunctions.

Optionally, a main function may have no specific subfunctions, but can itself be a controllable vehicle function. A vehicle function can then be (pre-)selected directly via the first input device and is merely confirmed via the second input device in order to be executed.

A vehicle function can thus be a main function, but also a subfunction.

For example, a main function is a menu item such as “radio”, “media”, “navigation”, “telephone” or a (pre-)selection of a track from a track list in “music” or a (pre-)selection of a telephone directory entry from a telephone directory, which then still has to be confirmed (via the second input device).

A subfunction may be an individual function, e.g. “increase volume”, a specific map display or a confirmation of the preselection of the main function (“OK”), or a collective function, e.g. “adjust volume”, “scroll up/down”, “back” to get to the previous overview, or similar.

A collective function (e.g., “adjust volume”) has two or more individual functions (e.g., “increase volume” and “decrease volume”), wherein a first individual function (e.g., “increase volume”) is executed while performing a first input gesture (e.g., “drag to the right”) and optionally a second, e.g., opposite individual function (e.g., “decrease volume”) can be executed during the same input process by a second, e.g., opposite input gesture (e.g., “drag to the left”).

An individual function can be executed after an input gesture (e.g. “tap”) or during an input gesture (e.g. “tap and hold”). However, it is not possible to perform another input gesture during the input process to control another individual function.

In particular, the processing unit is arranged to make a distinction between and recognize a choice of the main function and a selection of the main function, wherein the choice and/or the selection of the main function is performed by at least one input via the first input device. Thus, different operating parameters, for example previews of the subfunctions assigned to the main function, may be present in the different states—chosen state and selected state—of the main functions.

In the case of a choice corresponding to a preselection, the desired main function is merely “marked” via the first input device. For confirmation, a selection must still be made via the first or the second input device. The selection can be carried out, for example, via an input gesture or via some kind of persistence over a defined period of time at the chosen main function. If the selection is also made via the first input device, a subfunction can be selected from a corresponding set of subfunctions via the second input device.

Already in the chosen state of a main function, a set of subfunctions specific to the main function can be provided for control. Thus, a kind of “preview” of the subfunctions assigned to the main function can be enabled.

The processing unit may be arranged to control a specific vehicle function assigned to a specific main function or subfunction at least on the basis of an input via the first input device and/or via the second input device. Accordingly, certain vehicle functions can be controlled by a combined input via the first and the second input device, or certain vehicle functions can (additionally) be controlled only by an input via the first input device or only by an input via the second input device. In this way, further options for operating the operating system can be created, which can further increase the user-friendly operability of the operating system.

In particular, the first input device and/or the second input device comprise(s) a capacitive sensor system, an optical sensor system, a force sensor system and/or a mechanical sensor system, for example an electrical switch, such as a microswitch. Different input gestures can be recognized in different ways via the corresponding sensor system, and different vehicle functions (main and/or subfunctions) can thus be controlled.

For example, one of the two input devices or both input devices has/have a touch-sensitive surface, in particular a capacitive touch-sensitive surface, a rotating actuator, a switch, a knob and/or a button. The rotating actuator, the switch, the knob and/or the button may be configured in a purely mechanical way; additionally or alternatively, a capacitive sensor system, an optical sensor system and/or a force sensor system may be assigned. Therefore, a pressure-sensitive surface, which is provided in the case of a switch, a knob and/or a button, represents a particular type of a touch-sensitive surface.

In principle, a force sensor system can be configured such that the processing unit can recognize and distinguish between at least two different force strengths to which different functions are assigned. For example, a light force only results in a preselection, whereas a strong force, i.e. a force greater than the light force, results in a selection.

A further embodiment provides that at least a haptic, optical and/or acoustic feedback device is or are assigned to the first input device and/or the second input device.

The haptic feedback may take place actively, for example by an actuator such as an electric motor controlled by the processing unit. In this way, different feedback patterns can be generated, depending for example on the vehicle function chosen or selected.

Additionally or alternatively, the haptic feedback may take place passively, for example by structural components on the corresponding input device, such as recesses, grooves or protrusions. Thus, an additional haptic feedback type can be provided. Furthermore, the additional components for a separate active haptic feedback device can be saved. This saves costs and installation space.

The optical feedback device may comprise a screen and/or a light connected to the processing unit in a signal-transmitting manner. The light can be integrated in the steering wheel, for example in the steering wheel rim. A display may of course be realized on a screen.

The acoustic feedback device may comprise a loudspeaker via which a corresponding signal tone is emitted.

Overall, the feedback device(s) permit(s) feedback to the vehicle occupant or the operator of the operating system.

According to one aspect, at least the first input device and the processing unit are configured to recognize a number of points of contact on the first input device and to cause a change in an input parameter, for example a scrolling speed through the main functions and/or subfunctions, depending on the number of recognized points of contact. The vehicle occupant can thus reach a desired main function more quickly. In other words, the scroll speed increases provided that more fingers are detected at the first input device during scrolling, even though the movement speed of the fingers is the same. This allows the operator to scroll more quickly through a list, such as a song list, a telephone directory list, or a menu list.

The first input device and the processing unit may also be configured to detect the movement speed of at least one finger, in particular wherein the first input device and the processing unit are configured to cause a change of an input parameter, for example a scrolling speed through the main functions and/or subfunctions, based on the detected movement speed of the at least one finger. Thus, in addition to the number of recognized points of contact, the movement speed of the at least one finger can also be recognized and used to change the input parameter.

A further aspect provides that the first input device and/or the second input device comprise(s) an internal display device. This allows the vehicle functions available to be displayed to an operator, which facilitates the operation of the operating system. In particular, the (pre-)selected main function and/or a selectable subfunction can be displayed via the internal display device, for example via a corresponding icon and/or text, for example when a main function is preselected, the associated subfunctions can be displayed as a preview. In other words, the corresponding vehicle function can be displayed via a icon and/or text on the internal display device. For this purpose, a display screen may be provided on the steering wheel, for example on the front side of the steering wheel facing the driver, and may for example be integrated in a steering wheel spoke.

Preferably, the display device is touch-sensitive so that a displayed vehicle function can be chosen, selected or executed by an input in the area of the displayed vehicle function. This can further facilitate the operation of the operating system.

Accordingly, the touch-sensitive display device may be the second input device. The touch-sensitive display device can be used to display and select or confirm the subfunctions (as a preview).

The internal display device, in particular that of the first input device, can be formed by lights, for example LEDs. Different colors of the lights can be used to visually represent different states of the associated input device, for example the choice, preselection or selection, and/or different main functions or subfunctions.

Alternatively or additionally, a display device may be provided which is designed separately from the first input device and the second input device and which is connected to the processing unit. Inputs via the first and/or via the second input device can be visualized by this external display device, thus further facilitating the operation of the operating system. The external display device may be a main screen, for example a central screen on the dashboard or in the vehicle cockpit. The separately formed display device can also be in a head-up display in which the vehicle driver can maintain his or her head posture or viewing direction because the corresponding information is projected into his or her field of view. The information can be projected directly onto the windshield or onto a screen formed separately for this purpose.

It is in particular provided that the external display device visualizes an input via the first input device and the internal display device of the second input device displays specific subfunctions of the main function preselected by the input of the first input device. In particular, the specific subfunctions of the main function preselected by the input of the first input device can be selected via the internal display device, which is designed to be touch-sensitive. Accordingly, the external display device is assigned to the first input device, and the internal display device of the second input device is assigned to the second input device. The separate display of the main functions and subfunctions increases the clarity of the operating system.

The processing unit may be arranged to generate a graphical user interface comprising a menu with menu items which can at least be preselected via the first input device. Here, each menu item may correspond to a main function which can at least be preselected, i.e. at least adapted to be chosen, via the first input device, thereby selecting a set of subfunctions which can be controlled by an input via the first and/or via the second input device. A graphical user interface greatly facilitates the operation of the operating system and consequently increases the ease of use of the operating system. The graphical user interface may be displayed on the internal and/or external display device.

For example, the first and/or the second input device are/is designed in a web-like manner, in particular in a web-like manner. This allows an operation with up to four fingers simultaneously per input device. This also increases the ease of use for the vehicle driver, since he/she does not have to take the hands away from the steering wheel to operate the input device(s). The first input device, which is designed as a web, can be arranged on the steering wheel spoke or on a base of the steering wheel. The steering wheel may be coupled to a steering column or the like via the base.

In principle, the first and/or the second input device can be designed in a steering wheel-fixed or vehicle-fixed manner. Vehicle-fixed means that the first and/or the second input device maintain(s) their (absolute) position irrespective of the position of the steering wheel. In other words, the first and/or the second input device do/does not rotate with the steering wheel upon steering. In contrast thereto, steering wheel-fixed means that the first and/or the second input device rotate(s) with the steering wheel. However, the relative position to the steering wheel may remain.

In one embodiment, the processing unit is arranged to make a distinction between different input gestures and to operate different main functions and/or subfunctions depending on the input gestures. In this way, suitable and intuitive input gestures can be assigned to certain main functions and/or subfunctions, which makes the operation of the operating system easier or more user-friendly.

An input gesture may comprise one or more of the following gestures: “tap”, “double-tap”, “tap-and-hold”, “press”, “double-press”, “press-and-hold”, “drag”, “swipe”, “circle”, and “shuffle”. One or more input gestures can be performed during the input process. For example, a preselected main function can be confirmed by a double tap or a tap-and-hold so that the corresponding subfunctions can be selected.

The input gestures are not limited to one embodiment of an input device. For example, a press may be performed as an input gesture in the case of a touch-sensitive surface having a capacitive sensor system, as well as in the case of a pushbutton having a mechanical sensor system or a force sensor system. As a further example, a circular movement can be performed in the case of a touch-sensitive surface having a capacitive sensor system as well as in the case of a rotating actuator having a mechanical sensor system, for example in order to increase or decrease a volume depending on the direction of rotation.

Furthermore, the object is achieved according to the invention by a method for operating a motor vehicle, comprising the steps of:
detecting at least one finger of an operator on a first input device which is arranged on a steering wheel and is assigned to a first side of the steering wheel,
preselecting a main function by means of the at least one detected finger,
providing a subfunction assigned to the preselected main function on a second input device which is arranged on the steering wheel and is assigned to a second side of the steering wheel which is opposite to the first side, and
operating the second input device to control a vehicle function depending on the subfunction assigned to the preselected main function.

Due to the locally and thematically separate choice or selection of the main functions or of the assigned subfunctions, a large number of available vehicle functions can be controlled in a clear manner, thus enabling intuitive and clear control of the subfunctions.

The main function can be assigned to at least one detected finger by a manual choice of the main function or automatically based on the (relative) position and number of detected fingers on the first input device.

It may be provided that the main function is assigned to the at least one detected finger based on the relative location or the absolute position of the at least one detected finger on the first input device.

If the main function is assigned to the at least one finger based on the relative location of the finger on the first input device, the operator does not have to pay so much attention to the exact placement of the fingers on the input device, as the input areas assigned to the individual main functions can be configured larger here.

In particular, the assignment is here performed automatically, which is why the operator does not have to pay attention to find the correct (absolute) position for the corresponding main function.

When assigning the main function to the at least one finger based on the absolute position of the finger on the first input device, the input areas of the main functions are clearly delimited from each other, making it easier for the operator to recognize the correlation between the point of contact and the displayed main function.

In particular, the assignment is here performed manually, as the operator purposefully places his or her finger on the absolute position on the first input device assigned to the desired main function.

The relative location may be defined by a relative movement of the at least one finger or by the relative location of the fingers to each other.

Alternatively, the first input device may be subdivided into different sections which are each assigned to a main function. Due to the absolute position of one or more fingers in one or more sections of the first input device, one or more main functions are assigned to the finger or fingers.

In particular, the preselected main function is confirmed via the subfunction assigned thereto and/or a (pre-)selection of a main function and/or a subfunction is made via one or more input gestures. The selection of the preselected main function is then performed via the second input device. As explained above, the subfunction executed via the second input device can also be a confirmation of the preselected main function, i.e. an “OK” or a “make call” of the previously selected telephone directory entry or a “play” of the previously selected song. In addition, suitable and intuitive input gestures may be assigned to certain main functions and/or subfunctions, thereby facilitating the operation of the operating system or making it more user-friendly. Examples of input gestures have already been discussed above.

One aspect provides that the preselected main function is confirmed automatically after the expiration of a time period and/or due to an exerted pressure, in particular wherein further fingers previously resting on the first input device are (must be) removed to confirm the selection. The confirmation results in a selection of the main function. In this way, it is intuitively possible to select the desired main function without having to remove the currently used hand to perform another input or having to take another hand to confirm the main function.

The selection can of course also be made by performing an input gesture.

Optionally, at least one icon may be represented on a display device assigned to the preselected main function and/or subfunction. This allows an operator to easily and quickly recognize which main function is currently chosen or which subfunctions can be controlled, for example based on a preview of the subfunctions assigned to the preselected main function.

The icon may be a menu or a menu item of the menu of a graphical user interface.

The display device may be an internal display device of the second input device or an external display device. The main functions and/or subfunctions are in particular visualized on the external display device, and the main functions and/or subfunctions of a main function are visualized on the internal display device.

As explained above, the second input device may be configured in a web-like or rocker-like manner. In particular, the first input device and the second input device are provided on a common web, but on opposite sides of the web. The first input device is arranged on the side facing away from the driver, whereas the second input device is arranged on the side facing the driver. Along the side facing the driver, the driver can also perform a swiping motion or the like with his thumb to quickly and intuitively scroll through several subfunctions.

The input device may be arranged on a steering wheel spoke and may in particular be formed integrally with the steering wheel spoke or attached to the steering wheel spoke.

It may also be provided that the first input device is arranged on the steering wheel rim, for example as a mechanical rotary wheel or as a touch-sensitive input device.

It is generally possible for the driver to operate the first input device with four fingers, namely the index finger, middle finger, ring finger and little finger, and simultaneously operate the second input device with his thumb. Thus, the driver can operate both input devices with one hand without removing his hand from the steering wheel, even though the input devices are assigned to opposite sides of the steering wheel.

The described advantages and properties of the operating system according to the invention apply equally to the method for operating a motor vehicle and vice versa.

Further advantages and properties of the invention will become apparent from the following description and from the accompanying drawings, to which reference is made and in which:

FIG. 1 shows a schematic representation of a cockpit of a motor vehicle,

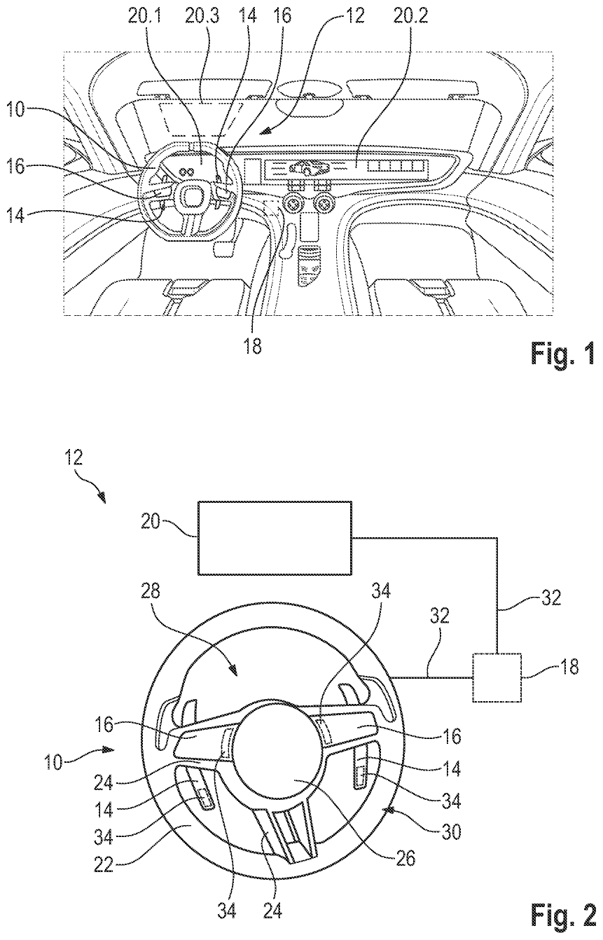

FIG. 2 shows a schematic representation of an operating system of the motor vehicle according to the invention as shown in FIG. 1,

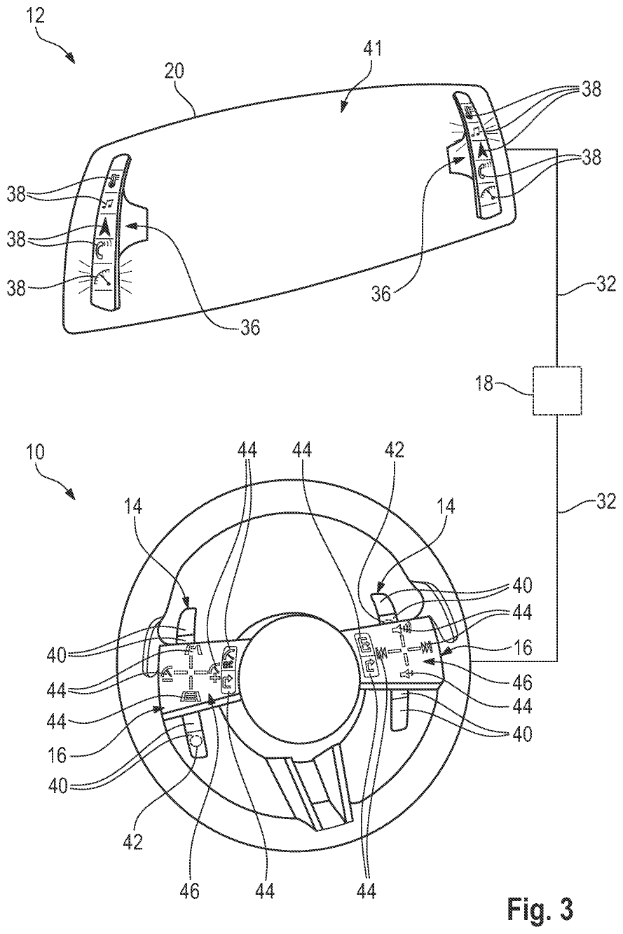

FIG. 3 shows a schematic representation of a first embodiment of the operating system according to the invention as shown in FIG. 2,

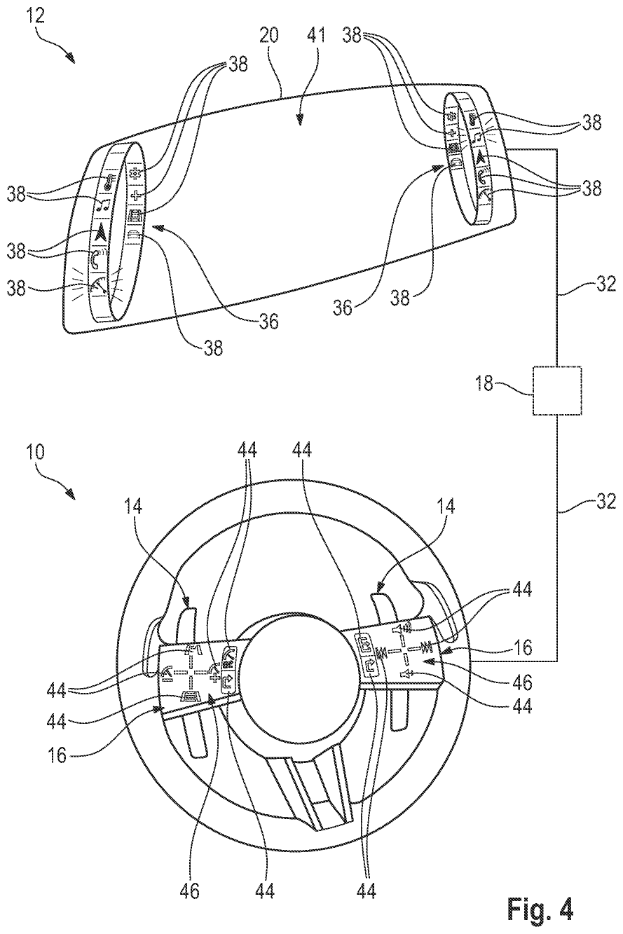

FIG. 4 shows a schematic representation of a second embodiment of the operating system according to the invention as shown in FIG. 2,

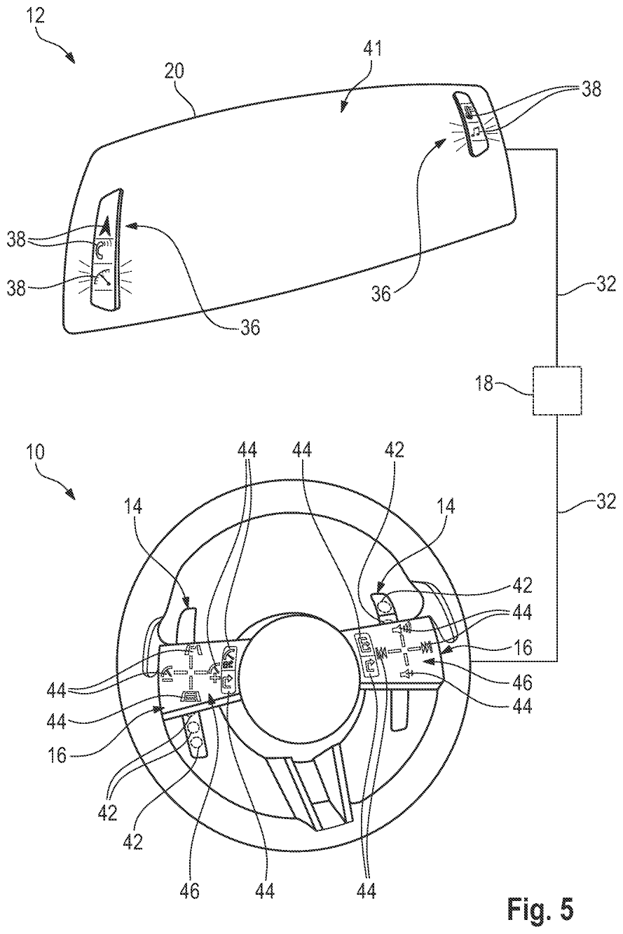

FIG. 5 shows a schematic representation of a third embodiment of the operating system according to the invention as shown in FIG. 2,

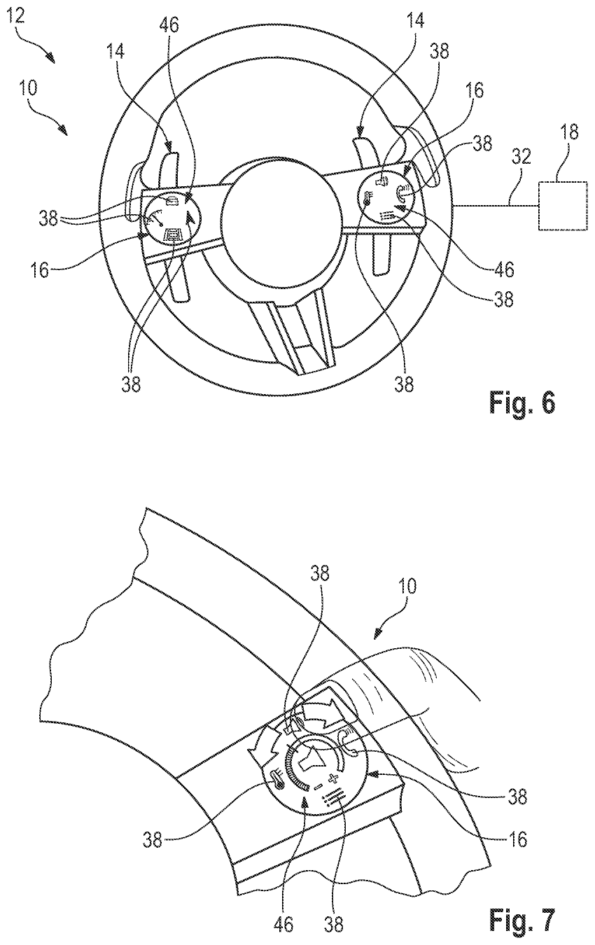

FIG. 6 shows a schematic representation of a fourth embodiment of the operating system according to the invention as shown in FIG. 2, and

FIG. 7 shows a detailed view of an operating variant of the operating system according to the invention as shown in FIG. 6.

FIG. 1 shows a cockpit of a vehicle.

The vehicle has various vehicle components, such as a steering wheel 10, a driver's seat, a passenger seat, a dashboard, a center console and further components.

In addition, an operating system 12 is provided via which vehicle functions of the vehicle, such as an entertainment system and a navigation system, among others, can be controlled.

In the example embodiment shown, the operating system 12 comprises two first input devices 14, two second input devices 16, at least one processing unit 18, and a plurality of external display devices 20.

For example, the processing unit 18 comprises at least one processor, a data memory, a working memory, and/or the like. The processing unit 18 may in particular also comprise a plurality of processors.

The first input devices 14 and the second input devices 16 are connected to the processing unit 18 in a signal-transmitting manner, so that an input via the first input devices 14 and/or the second input devices 16 can be processed by the processing unit 18.

In addition, the processing unit 18 is connected to the plurality of display devices 20 in a signal-transmitting manner so that corresponding information provided by the processing unit 18 can be displayed.

The first input devices 14 are arranged on a rear side of the steering wheel 10, that is, facing away from an operator, whereas the second input devices 16 are arranged on a front side of the steering wheel 10, that is, facing the operator.

Accordingly, the first input devices 14 and the second input devices 16 are provided on opposite sides of the steering wheel 10.

In the embodiment shown, the first input devices 14 have a web-like configuration, which can be seen more clearly in FIG. 2. In addition, the first input devices 14 have touch-sensitive surfaces, for example capacitive surfaces, via which a manual input can be made.

The second input devices 16 also have touch-sensitive surfaces, for example capacitive surfaces, via which a manual input can also be made.

Two screens 20.1, 20.2 in the dashboard are provided as external display devices 20 in FIG. 1, and a screen of a head-up display 20.3 (HUD) also serves as a display device 20.

However, the number of input devices 14, 16 is to be understood as exemplary only. The operating system 12 may likewise be implemented with only one first input device 14 and/or only one second input device 16 or any other number of first and/or second input devices 14, 16.

The number of external display devices 20 is also to be understood as exemplary. The operating system 12 may likewise have no or any other number of external display devices 20.

Inputs which are processed by the processing unit 18 and can optionally be displayed on at least one of the external display devices 20 can be made by an operator via the input devices 14, 16.

FIG. 2 shows the operating system 12 in more detail. For clarity, the operating system 12 is shown here with only one external display device 20.

In the embodiment shown, the steering wheel 10 has a steering wheel rim 22, three steering wheel spokes 24 and a center section 26 in which, for example, an airbag can be accommodated.

The steering wheel 10, in particular the steering wheel rim 22, defines a plane having a first side 28 and a second side 30 opposite the first side 28.

Here, the first side 28 corresponds to a rear side of the steering wheel 10 facing away from an operator, and the second side 30 corresponds to a front side of the steering wheel 10 facing the operator.

As already explained, the first input devices 14 have touch-sensitive surfaces which are assigned to the first side 28, i.e. have their active surface facing away from the operator. In this respect, the first input devices 14 are mounted on the rear side of the steering wheel 10, in particular on the steering wheel spokes 24. The first input devices 14 may be attached to the steering wheel spokes 24 as separately formed switching elements. The first input devices 14 may also be integrated in the steering wheel spokes 24.

The design and attachment of the first input devices 14 is to be understood as exemplary only. The first input devices 14 may have any other shape, mode of operation, or positioning.

In particular, the first input devices 14 may also be arranged on the steering wheel rim 22 or on a base of the steering wheel 20, wherein they are assigned to the first side 28, i.e. the rear side of the steering wheel 10, or wherein their operating surface faces away from the operator or the driver.

In other words, one or both of the first input devices 14 may be arranged at a different location of the steering wheel 10, and for example be integrated in the steering wheel spoke 24 or in the steering wheel rim 22.

It is also conceivable that one or both of the first input devices 14 is/are mounted on a (substantially) immovable part of the cockpit, so as to not rotate with the steering wheel 10. This is also referred to as a vehicle-fixed arrangement of the first input devices 14, as the absolute position of the first input devices 14 is maintained, regardless of the steering wheel position.

For example, one or both of the first input devices 14 may include a capacitive sensor system, an optical sensor system, a force sensor system, or a mechanical sensor system. A combination of different sensor systems per input device 14 is also possible. Furthermore, the first input devices 14 may each comprise different sensor systems.

Instead of or in addition to the touch-sensitive surface, one or both of the first input devices 14 may, for example, comprise one or more mechanical buttons, mechanical wheels or the like. Accordingly, the shape may of course also differ from a web-like shape.

It may further be provided that a haptic, optical and/or acoustic feedback device 34 is assigned to the first input devices 14 and/or the second input devices 16.

The haptic feedback by the feedback device 34 may take place actively, for example by an actuator controlled by the processing unit 18, in particular an electric motor.

Additionally or alternatively, the haptic feedback may take place passively, for example by structural components arranged on the first input device 14 and/or the second input device 16, such as recesses, grooves or protrusions, which are haptically sensed by the operator of the operating system 12 when the operator actuates the corresponding input device 14, 16.

The properties, features, and variations of the first input devices 14 described above are generally equally applicable to the second input devices 16.

One or both of the second input devices 16 may or may not include an internal display device. The latter can, for example, be designed to be touch-sensitive and thus form a touch screen.

The processing unit 18 is in signal or data connection 32 with the steering wheel 10, in particular with the input devices 14, 16, and the external display device 20. The signal or data transmission may be wired or wireless.

The external display device 20 can be used to visualize inputs via the first input devices 14 and/or the second input devices 16.

In the following, the general operation of the operating system 12 will be explained. FIGS. 3 to 7 describe special variants of the operation of the operating system 12.

To operate the operating system 12, the operator makes an input at one of the first input devices 14 with one or more fingers by placing the at least one finger on the touch-sensitive surface.

The input causes a main function to be at least preselected via the processing unit 18.

A preselection corresponds here to a choice of the main function. The preselection can be confirmed in a further input step, which corresponds to a selection of the main function. The processing unit 18 is able to make a distinction between and recognize a choice of the main function and a selection of the main function.

In the case of a selection, the choice must additionally be confirmed. The confirmation can for example take place via a time period or a further input, in particular also by an input via the second input device 16.

By (pre)selecting the main function via the first input device 14, a certain set of subfunctions specific to the preselected main function can be controlled. The main function thus represents a categorization or a menu item in which subfunctions that are usual for and specific to the category or menu item are classified.

The subfunctions specific to the main function are provided to the second input device 16 after the (pre)selection of the main function by the first input device 14 and can be controlled by an input via the second input device 16.

The provision of the subfunctions assigned to the main function can (additionally) be carried out visually by displaying the available subfunctions on the internal display device of the second input device 16 and/or on the external display device 20. This is also clearly shown in FIG. 3.

Optionally, the first input device 14 can also perform a kind of “shift” function. It is thus possible by an actuation, for example a tilting (similar to shift rockers), a pressing, a touching or the like of the first input device 14 to change to a shift mode and, when the actuation is terminated, to maintain or terminate the shift mode, thus switching back to the default mode. A further actuation of the first input device 14 may terminate the shift mode or change to another shift mode.

For example, other main functions and/or subfunctions can be provided for a (pre)selection in the shift mode. Additionally or alternatively, an input parameter may be changed in the shift mode, e.g., the scrolling speed may be reduced to an incremental scrolling in the default mode, and a faster scrolling may be provided in the shift mode.

Thus, the “shift” function can be used to switch between different sets of main functions or subfunctions.

Therefore, the core idea of the operating system 12 or the method for operating the operating system 12 is the combined operation of the first input devices 14 and the second input devices 16.

Accordingly, the first input devices 14 are operatively coupled to the second input devices 16.

The input for a (pre)selection of the main functions only via one of the first input devices 14 has been described above. In this variant, both first input devices 14 are interdependently coupled, i.e. the operation of one input device 14 has an influence on the operation of the other input device 14.

For example, the operator performs a scrolling through the main functions via the right-hand first input device 14, which however must be interrupted, for example, due to a necessary shifting operation using a gearshift lever. The operator can then continue scrolling at the point where scrolling was interrupted using the left-hand first input device 14. Therefore, both first input devices 14 act together here as a common first input device 14.

The properties described above may also apply to the second input devices 16.

As an alternative variant, the first input devices 14 may also be operated independently of each other. This means that the first input devices 14 are each assigned a mutually identical or different set of main functions, from which a main function can be (pre)selected independently of one another by a respective one of the two first input devices 14. For example, the left-hand first input device 14 is assigned only main functions relating to the “media” area, such as “telephone”, “radio”, “music”, etc., whereas the right-hand first input device 14 is assigned only main functions relating to other vehicle functions of the vehicle, such as “air conditioning”, “navigation”, “system settings”, etc.

The properties described above may also apply to the second input devices 16.

FIGS. 3 to 7 show specific variants of the operation of the operating system 12.

Here, the first input devices 14 have touch-sensitive surfaces and the second input devices 16 have touch-sensitive display surfaces (touch screens) that can be operated independently of each other.

In addition, the input devices 14, 16 are coupled to the external display device 20.

It goes without saying that the embodiments shown in FIGS. 3 to 7 are to be understood as examples only, and that the individual components of the operating system 12 may also have other properties, features and modes of operation—as explained in the foregoing.

In a first operating variant of the operating system 12 according to FIG. 3, a main function set 36 is respectively assigned to a first input device 14, the main function sets 36 each having five mutually identical main functions 38, for example “climate control”, “music”, “navigation”, “telephone” and “assistance systems”, in particular “driving assistance systems”.

Furthermore, different driving modes can for example be controlled by the first input device 14 and/or the second input device 16.

Here, one of the first input devices 14 is respectively subdivided virtually and optionally structurally into sections 40 corresponding to the number of main functions 38 in the main function set 36, for example by passive haptic feedback devices such as recesses and/or elevated parts.

Optionally, this may also be the case for the second input device 16.

The processing unit 18 is arranged to generate a graphical user interface 41 on the external display device 20 comprising the main function sets 36 as a menu with the individual main functions 38 as menu items.

As soon as the operator places a finger on the first input device 14, the processing unit 18 detects a point of contact 42 on the touch-sensitive surface via the first input device 14.

Depending on the section 40 in which the point of contact 42 is located, a main function 38 assigned to the respective section 40 is chosen, as shown in FIG. 3 by a plurality of marking lines around the corresponding main function 38.

Subfunctions 44 specific to the main function 38 can be assigned to the second input device 16 already in a chosen state of a main function 38 and optionally be displayed by the second input device 16, in particular as a preview, for example on the integrated display device on the front side of the steering wheel 10.

Alternatively, the subfunctions 44 specific to the main function 38 may be assigned to the second input device 16 and optionally be displayed by the second input device 16 only after a selection of the corresponding main function 38.

The selection of a chosen main function 38 may take place, for example, by removing the finger from the section 40 of the associated chosen main function 38, by making a specific gesture, such as “tap” or “press”, in particular with a higher force, or by remaining in the chosen state for a specific period of time.

Several fingers may also rest on the first input device 14 and thus create several points of contact 42 in different sections 40.

The processing unit 18 can then detect how many fingers are resting on the input device 14, i.e. the touch sensitive surface, and in which sections 40 the points of contact 42 are located.

A main function 38 assigned to the respective section 40 is chosen depending on which sections 40 the individual points of contact 42 are located in.

Here, a selection of a main function 38 can also be made by removing the fingers from the sections 40 assigned to the main functions 38 that are not to be selected, as described above.

Thus, the (pre)selection of the main functions 38 is dependent on an absolute location of the point of contact 42 on the first input device 14. Or, in other words, the main function 38 assigned to the at least one of the detected fingers is assigned based on the absolute position of the finger on the first input device 14.

The confirmation or selection of a chosen main function 38 may also be performed via the second input device 16.

It may be provided that a particular gesture and/or a determined number of points of contact 42 may initiate a change in the menu of the graphical user interface 41.

For example, a “swipe” of the finger across a plurality of sections 40 may cause the currently listed main functions 38 to be replaced by other main functions 38.

By (pre)selecting a main function 38, subfunctions 44 specific to the main function 38 are assigned to the second input device 16. Optionally, the subfunctions 44 may be displayed on the second input device 16 such that a graphical user interface 46 is created on the second input device 16 by the processing unit 18.

A subfunction 44 can then be controlled, preferably with only one finger (thumb) by a gesture, for example “tap” or “press”.

The subfunctions 44 shown in FIG. 3 are all individual functions.

An individual function can be executed after a gesture, for example “tap”, or during a gesture, for example “tap and hold”. However, it is not possible to perform another gesture during the input process to control another individual function.

Two or more individual functions can be combined in a collective function. Accordingly, a collective function has two or more individual functions, wherein a first individual function is performed during the execution of a first gesture (e.g. “pull to the right”) and optionally a second, e.g. opposite individual function can be executed during the same input process by a second, e.g. opposite input gesture (e.g. “pull to the left”). A collective function is shown in more detail in FIG. 7, to which reference will be made below.

It may be provided that a particular gesture initiates a change in the menu of the graphical user interface 46. For example, “circling” the thumb over a plurality of subfunctions 44 may cause the currently listed subfunctions 44 to be replaced by other subfunctions 44.

Only the operation using a first input device 14 and a second input device 16 has been discussed above. Operation can of course also be performed simultaneously on both first input devices 14 and both second input devices 16.

In this case, it is possible that different main function sets 36 are assigned to each of the first input devices 14.

The operating concept described above is illustrated below using the specific example shown in FIG. 3.

An operator places one of his left fingers on the fifth section 40 of the left first input device 14 counted from the top of the first input devices 14, and places one of his right fingers on the second section 40 of the right first input device 14.

On the one hand, the main function 38 “assistance systems”—on the left in the graphical user interface 41 of the external display device 20—and, on the other hand, the main function 38 “music”—on the right in the graphical user interface 41 of the external display device 20—are thus chosen.

Optionally, the chosen main functions 38 are confirmed and thus selected by a selection gesture, for example “tap” or “press”, by a removal of the finger from the section 40 of the chosen main function 38 or by a period of time.

During or shortly after the pre-selection or during or shortly after the selection, subfunctions 44 corresponding to the (pre)selected main function 38 are displayed on the internal display device of the second input devices 16, as is apparent from FIG. 3.

Starting at the top in a clockwise direction around the control pad, these are for the main function 38 “assistance systems” the subfunctions 44 “lane keeping assistant”, “increase cruise control speed”, “distance control assistant” and “decrease cruise control speed”.

Radially further inward with respect to the steering wheel 10, the subfunction “turn cruise control off or on” is shown at the top and the standard subfunction “undo or exit” is shown at the bottom.

Starting at the top in a clockwise direction around the control pad, these are for the main function 38 “music” the subfunctions 44 “increase volume”, “next track”, “decrease volume” and “previous track”.

Radially further inward with respect to the steering wheel 10, subfunction 44 “confirm” is shown at the top and the standard subfunction “undo or exit” is shown at the bottom.

As mentioned above, the subfunctions 44 shown are all individual functions.

An individual function can be executed after a gesture, e.g. “tap”, or during a gesture, e.g. “tap and hold”.

For example, a “tap” on “increase cruise control speed” increases the speed gradually with each “tap”, whereas a “tap and hold” increases the speed more quickly and continuously during the hold.

A “tap” on “next track” will skip to the next track, wherein a fast forwarding of the current track can be performed by a “tap and hold”.

It is however not possible to perform another gesture during the input process to control another individual function.

Alternatively, one or more related subfunctions 44, for example “increase cruise control speed” and “decrease cruise control speed”, “increase volume” and “decrease volume”, or “next track” and “previous track”, may be formed as a collective function.

It is for example possible to increase the volume during a “swipe up” and to optionally “swipe down” in the current input process, thereby decreasing the volume during the “swipe down”.

A second operating variant of the operating system 12 according to FIG. 4 is similar to the first operating variant.

Here, the number of main functions 38 of a main function set 36 is however not limited to the number of virtual sections of the first input device 14, but the main function set 36 is set up per first input device 14 as a kind of endless list (“scroll”), the endless lists of the two first input devices 14 having mutually identical main functions 38.

The processing unit 18 is configured to generate a graphical user interface 41 on the external display device 20, which comprises the main function sets 36 as a menu with the individual main functions 38 as menu items.

As soon as the operator places one or more fingers on the first input device 14, the processing unit 18 detects one or more points of contact 42 via the first input device 14.

It may be provided that the start choice of a main function 38 is dependent on the touch position on the first input device 14.

Alternatively, the start choice may always be the same, in particular individually adjustable “default” main function 38 or the last active main function 38.

If the point of contact 42 is located in the upper area of the first input device 14, a main function 38 located in the upper area of the menu of the graphical user interface 41 is more likely to be chosen for start.

A gesture, for example “swipe”, can be used to scroll through the menu of main functions 38 and choose one main function 38 at a time.

It is here conceivable that an input parameter can be changed depending on a number of points of contact 42 performing the scroll gesture. For example, an input parameter may be a scroll speed through the menu of the main functions 38.

The input parameter, for example the scroll speed, may additionally or alternatively be changed depending on the movement speed of the at least one finger across the corresponding input device 14 and/or by an initiation of a shift mode (“shift” function).

Alternatively, only incremental scrolling may be provided, which is independent of the number of points of contact 42, the speed of movement of the at least one finger and/or the initiation of a shift mode.

A mechanical wheel and/or mechanical buttons may for example be used instead of a touch-sensitive surface.

It is also conceivable that the complete first input device 14 is tilted similar to a rocker in order to perform a, in particular incremental, scrolling through the main functions 38.

Subfunctions 44 specific to the main function 38 can be assigned to the second input device 16 already in the chosen state of a main function 38 and optionally be displayed by the second input device 16.

Alternatively, the subfunctions 44 specific to the main function 38 may be assigned to the second input device 16 and optionally be displayed by the second input device 16 only after a selection of the corresponding main function 38.

The selection of a chosen main function 38 may take place, for example, by removing the finger from the first input device 14, by making a specific gesture, such as “tap” or “press,” or by remaining in the chosen state for a specific period of time.

The (pre)selection of the main functions 38 is thus dependent on the relative movement of the point of contact 42 on the first input device 14.

Or, in other words, the main function 38 assigned to the detected finger is assigned based on the relative location or the relative movement of the finger on the first input device 14.

In this respect, it is not necessary for the operator to find the absolute position of the corresponding main function 38, as the corresponding main function 38 is determined based on a relative location or a relative movement of the at least one finger, irrespective of the absolute position at which this is done.

The confirmation or selection of a chosen main function 38 may also be performed via the second input device 16.

With regard to the subfunctions 44, reference is made to the explanations as to the first operating variant according to FIG. 3.

Only operation using a first input device 14 and a second input device 16 has been discussed above.

Operation can of course also be performed simultaneously on both first input devices 14 and both second input devices 16.

The operating concept described above is illustrated below using the specific example shown in FIG. 4.

An operator places one of his left fingers on an area of the left first input device 14 and one of his right fingers on an area of the right first input device 14.

As a result, on the one hand, a main function 38 corresponding to the touch position of the left first input device 14 is chosen in the left menu of the graphical user interface 41 of the external display device 20 for starting, and on the other hand, a main function 38 corresponding to the touch position of the right first input device 14 is chosen in the right menu for starting.

It may be provided that the start choice of a main function 38 is dependent on the touch position on the first input device 14.

Alternatively, the start choice can always be the same, in particular individually adjustable “default” main function 38 or the last active main function 38.

The operator then “swipes” with his left and/or right finger in the direction of the desired main functions 38—in this case the main functions 38 “assistance systems” or “music”- and thus chooses them, as shown in FIG. 4 by several marking lines around the corresponding main functions 38.

Optionally, the chosen main functions 38 are confirmed and thus selected by a selection gesture, for example “tap” or “press”, by removing the finger from the section 40 of the chosen main function 38 or by a period of time.

During or shortly after the preselection, or during or shortly after the selection, subfunctions 44 corresponding to the preselected main function 38 are displayed on the internal display device of the second input devices 16.

For the descriptions of the main functions 38 and subfunctions 44 (individual functions and collective functions), reference is made to the explanations as to the first operating variant according to FIG. 3.

A third operating variant of the operating system 12 according to FIG. 5 is similar to the first operating variant.

Here, however, the main functions 38 of a main function set 36 are not assigned to virtual sections of the first input device 14, but the at least one main function 38 is assigned to the at least one point of contact 42 of the at least one finger touching the first input device 14.

The processing unit 18 is configured to generate a graphical user interface 41 on the external display device 20 which visualizes the main functions 38 assigned to the points of contact 42.

As soon as the operator places one or more fingers on the first input device 14, the processing unit 18 detects one or more points of contact 42 via the first input device 14.

Each point of contact 42 is assigned to a main function 38, which is thereby chosen.

Only the chosen main functions 38 are displayed on the external display device 20. Alternatively, the main functions 38 that are not chosen may be also displayed and the main functions 38 that are chosen may be highlighted in some manner.

It may be provided that the start choice of one or more main functions 38 is dependent on the point of contact 42 or points of contact 42 on the first input device 14.

Alternatively, the start choice may always be the same, in particular individually adjustable “default” main function 38 or the last active main function 38.

For example, if the point of contact 42 or points of contact 42 is/are located in the upper area of the first input device 14, one or more main function(s) 38 located in the upper area of the menu of the graphical user interface 41 are more likely to be selected for start. For this purpose, main function sets 36 may already be displayed in the menu prior to touching the first input devices 14.

Subfunctions 44 specific to the main function 38 may be assigned to the second input device 16 already in a chosen state of a main function 38 and optionally be displayed by the second input device 16.

Several fingers may also rest on the first input device 14 and thus create several points of contact 42, such that several main functions 38 are selected. In this case, however, no subfunctions 44 can be assigned to the second input device 16 in a selected state of the main functions 38 and optionally be displayed by the second input device 16.

The processing unit 18 may then recognize how many fingers rest on the input device 14, that is, the touch-sensitive surface.

Here, a corresponding main function 38 may be assigned to each recognized finger, in particular based on a relative location of the fingers, so that a main function 38 is (pre-)selected as soon as the operator removes the fingers from the touch-sensitive surface, except for the finger whose assigned main function 38 is to be (pre-)selected.

The relative location of the finger with respect to the input device 14 is in particular recognized, i.e., the uppermost or lowermost finger on the touch-sensitive surface; regardless of whether the respective finger is the index finger or the middle finger.

Then, the correspondingly associated subfunctions 44 may be assigned to the second input device 16 in a chosen state of the main function 38 and optionally be displayed by the second input device 16.

Alternatively, the subfunctions 44 specific to the main function 38 may be assigned to the second input device 16 and optionally be displayed by the second input device 16 only after a selection of the corresponding main function 38.

The selection of a chosen main function 38 may take place, for example, by removing the finger of the assigned chosen main function 38, by making a specific gesture, such as “tap” or “press,” or by remaining in the chosen state for a specific period of time.

If several points of contact 42 have been created and thereby several main functions 38 are chosen, a selection of a main function 38 may also be made by removing the fingers assigned to the main functions 38 that are not to be selected.

Thus, the (pre)selection of the main functions 38 is dependent on a relative location of the point of contact 42 or points of contact 42 on the first input device 14. Or, in other words, the main function 38 assigned to the at least one of the detected fingers is assigned based on the absolute location of the finger on the first input device 14.

The confirmation or selection of a chosen main function 38 may also be performed via the second input device 16.

It may be provided that a particular gesture initiates a change in the menu of the graphical user interface 41. For example, a “swipe” of the finger or fingers may cause the currently chosen main functions 38 to be replaced by other main functions 38.

With regard to the subfunctions 44, reference is made to the explanations as to the first operating variant according to FIG. 3.

Only the operation using a first input device 14 and a second input device 16 has been discussed above. Operation can of course also be performed simultaneously on both first input devices 14 and both second input devices 16.

The operating concept described above is illustrated below on the basis of the specific example shown in FIG. 5.

An operator places three of his left fingers on a lower area of the left first input device 14 and two of his right fingers on an upper area of the right first input device 14.

As a result, on the one hand, main functions 38 (“navigation”, “telephone” & “assistance Systems”) corresponding to three of the points of contact 42 of the left first input device 14 are chosen for starting in the left menu of the graphical user interface 41 of the external display device 20, and only these are displayed.

On the other hand, main functions 38 (“climate” & “music”) corresponding to two of the points of contact 42 of the right first input device 14 are chosen for starting in the right menu, and only these are displayed.

The desired main functions 38 are selected by a selection gesture, for example “tap” or “press”, by a removal of the finger of the main function 38 to be selected or by a removal of the fingers of the main functions 38 not to be selected.

FIG. 5 shows the (pre-)selected main functions 38 (“assistance systems” & “music”) by several marking lines around the corresponding main function 38.

During or shortly after the pre-selection or during or shortly after the selection, subfunctions 44 corresponding to the (pre-)selected main function 38 are displayed on the internal display device of the second input devices 16.

For the descriptions of the main functions 38 and subfunctions 44 (individual functions and collective functions), reference is made to the explanations as to the first operating variant according to FIG. 3.

FIG. 6 shows a fourth operating variant. Here, the available main functions 38 are additionally or exclusively visualized in the menu of the graphical user interface 46 on the internal display device of the second input devices 16.

One main function 38 per operating page can then be (pre-)selected according to one of the (pre-)selection methods described above, and the subfunctions 44 can be controlled as described above.

Alternatively or additionally, when a main function 38 of the menu shown in FIG. 6 is controlled via the second input device 16, a collective function of the most important subfunctions 44 of the controlled main function 38 can be executed, as shown in FIG. 7. This collective function may, for example, be individually preset by the operator.

In the example shown, the collective function is “adjust volume” and comprises the two individual functions “increase volume” and “decrease volume”, which can be controlled by placing a finger on an icon of the desired collective function and the gesture “clockwise circular movement” or “counterclockwise circular movement”.

Matching subfunctions 44 in the operating variants according to FIGS. 2 to 5 may of course also be formed together as a collective function.

In the present case, the second input devices 16 are arranged on the steering wheel spokes 24 and face the driver.

Alternatively, the second input devices 16 can also be provided on the webs or rockers on which the first input devices 14 are arranged in the present case.

The first and second input devices 14, 16 are then arranged on opposite sides of the rockers or webs.

In an analogous manner, the second input devices 16 can be operated accordingly by the operator via the thumb.

The described properties, features and modes of operation of all operating systems described above can of course be freely combined, interchanged or the like.

1. An operating system for a motor vehicle, having
a steering wheel (10) for steering the motor vehicle, which comprises a steering wheel rim (22) and at least one steering wheel spoke (24),
a first input device (14) assigned to the steering wheel (10),
a second input device (16) assigned to the steering wheel (10), and
a processing unit (18) which is connected in a signal-transmitting manner to the first input device (14) and to the second input device (16), the processing unit (18) being configured to detect a manual input on the first input device (14) and a manual input on the second input device (16) and to convert them into a control of a vehicle function (38, 44),
characterized in that the first input device (14) is spatially separated from the second input device (16), the first input device (14) being assigned to a first side (28) of the steering wheel (10), and the second input device (16) being assigned to a second side (30) of the steering wheel (10) opposite to the first side (28), the first input device (14) and the second input device (16) being operatively coupled to the processing unit (18) such that a main function (38) can at least be preselected via the first input device (14), and a subfunction (44) assigned to the main function (38) can be controlled via the second input device (16).

2. The operating system according to claim 1, wherein the processing unit (18) is arranged to make a distinction between and recognize a choice of the main function (38) and a selection of the main function (38), the choice and/or the selection of the main function (38) being performed by at least one input via the first input device (14).

3. The operating system according to wherein the first input device (14) and/or the second input device (16) comprise(s) a capacitive sensor system, an optical sensor system, a force sensor system and/or a mechanical sensor system.

4. The operating system according to claim 1, wherein at least a haptic, an optical and/or an acoustic feedback device (34) are/is assigned to the first input device (14) and/or to the second input device (16).

5. The operating system according to claim 1, wherein at least the first input device (14) and the processing unit (18) are configured to recognize a number of points of contact (42) on the first input device (14) and to cause a change in one input parameter depending on the number of recognized points of contact (42).

6. The operating system according to claim 1, wherein the first input device (14) and/or the second input device (16) comprise(s) an internal display device.

7. The operating system according to claim 1, wherein a display device (20) is provided, which is formed separately from the first input device (14) and the second input device (16) and which is connected to the processing unit (18).

8. The operating system according to claim 1, wherein the processing unit (18) is arranged to generate a graphical user interface (41, 46) which comprises a menu including menu items which are at least adapted to be preselected via the first input device (14).

9. The operating system according to claim 1, wherein the first and/or the second input device (14, 16) are/is configured in a web-like or rocker-like manner.

10. The operating system according to claim 1, wherein the processing unit (18) is arranged to make a distinction between different input gestures and to control different main functions (38) and/or subfunctions (44) depending on the input gestures.

11. A method for operating a motor vehicle, comprising the steps of:
detecting at least one finger of an operator on a first input device (14) which is arranged on a steering wheel (10) and is assigned to a first side (28) of the steering wheel (10),
preselecting a main function (38) by means of the at least one detected finger,
providing a subfunction (44) assigned to the preselected main function (38) on a second input device (16) which is arranged on the steering wheel (10) and is assigned to a second side (30) of the steering wheel (10) which is opposite to the first side (28), and
operating the second input device (16) to control a vehicle function (38, 44) depending on the subfunction (44) assigned to the preselected main function (38).

12. The method according to claim 11, characterized in that the main function (38) is assigned to the at least one detected finger due to the relative location or the absolute position of the at least one finger on the first input device (14).

13. The method according to claim 11 wherein the preselected main function (38) is confirmed via the subfunction (44) assigned thereto and/or in that a (pre)selection of a main function (38) and/or a subfunction (44) is performed via one or more input gestures.

14. The method according to claim 11, wherein the preselected main function (38) is confirmed automatically after the expiration of a time period and/or due to an exerted pressure, in particular wherein further fingers resting previously on the first input device (14) are removed for confirming the selection.

15. The method according to claim 11, wherein at least one icon which is assigned to the preselected main function (38) and/or the subfunction (44) is represented on a display device (20).
